(19) United States
(12) Patent Application Publication
(10) Pub. No.: US 2008/0117555 A1
(43) Pub. Date: May 22, 2008

(54) ANTI-ARCING SYSTEM FOR POWER SURGE PROTECTORS

(75) Inventors: James A. Wilson, Post Falls, ID (US); Daniel J. Sullivan, Post Falls, ID (US); Richard R. Chadwick, Post Falls, ID (US)

Correspondence Address: MARGER JOHNSON & MCCOLLOM, P.C., 210 SW MORRISON STREET, SUITE 400, PORTLAND, OR, 97204, US

(73) Assignee: AC DATA SYSTEMS OF IDAHO, INC., Post Falls, ID (US)

(21) Appl. No.: 11/560,968

(22) Filed: Nov. 17, 2006

(51) Int. Cl. H01H 9/30; H01S 4/00

(52) U.S. Cl. 361/13; 29/592.1

(57) ABSTRACT

A surge suppression unit includes a circuit board containing electrical surge suppression components configured to redirect power surges. Anti-arcing separator walls are vertically aligned in between at least some of the electrical components for reducing electrical arcing. An epoxy may be spread in between the surge suppression components to both hold the separator walls upright while at the same time further retarding arcing. In another embodiment, the epoxy can be spread over substantially an entire top surface of the printed circuit board covering substantially all low profile electrical components while leaving a large portion of other higher profile MOVs or SADs uncovered. In yet another embodiment, the electrical components can also be covered with a fire retardant sand.

### FIELD OF INVENTION

This invention relates generally to reducing arcing in surge suppression devices.

### BACKGROUND

Surge suppression units are used for protecting electrical equipment from electrical power surges. There are many different arrangements of electrical components that are used for providing surge suppression. Generally, during normal non-power surge conditions, the surge suppression components provide a high resistance path between a power line and a neutral or ground line. When a power surge event happens, the surge suppressor components start conducting, shorting the power surge to ground or to a neutral line and away from any electrical equipment connected to the power line.

During these surge conditions, the surge suppression components that provide the shorting path for the power surge, such as power diodes or varistors, become hot and can explode and/or electrically arc to other components in the surge suppression unit. These explosions and arcing can damage other electrical surge suppression circuitry, such as other diodes or varistors that might have otherwise been used to provide surge suppression during subsequent power surges.

To reduce the undesirable effects from explosions and arcing, fuses are located in series with the diodes or varistors. The fuses are designed to blow at a particular power level that disconnects the associated diode or varistor from the power line experiencing the power surge. These fuses unfortunately reduce the overall power surge capacity of the surge suppression unit. In other words, the surge suppressor only redirects a power surge until the fuse blows. Thus, using a smaller fuse rating to prevent the undesirable effects of arcing also has the possible negative effect of reducing the overall peak current capacity of the surge suppression unit.

### BRIEF DESCRIPTION OF THE DRAWINGS

In the accompanying drawings which form a part hereof, and wherein like numbers of reference refer to similar parts throughout:

FIG. 1 is a perspective view of a surge suppression unit with improved arc resistance.

FIG. 2 is a circuit diagram for the surge suppression unit shown in FIG. 1.

FIG. 3 is a side sectional view of the surge suppression unit shown in FIG. 1.

FIG. 4 is a top view of another embodiment of the surge suppression unit that includes epoxy covering a printed circuit board.

FIG. 5 is a side sectional view of the surge suppression unit shown in FIG. 4.

FIG. 6 is a side sectional view of another embodiment of the surge suppression unit that contains a fire retardant sand.

FIG. 7 is a perspective cut-away view of two of the surge suppression units stacked in an enclosure.

FIG. 8 is a perspective cut-away view of another surge suppression system that includes different sized surge suppressor units.

### DETAILED DESCRIPTION

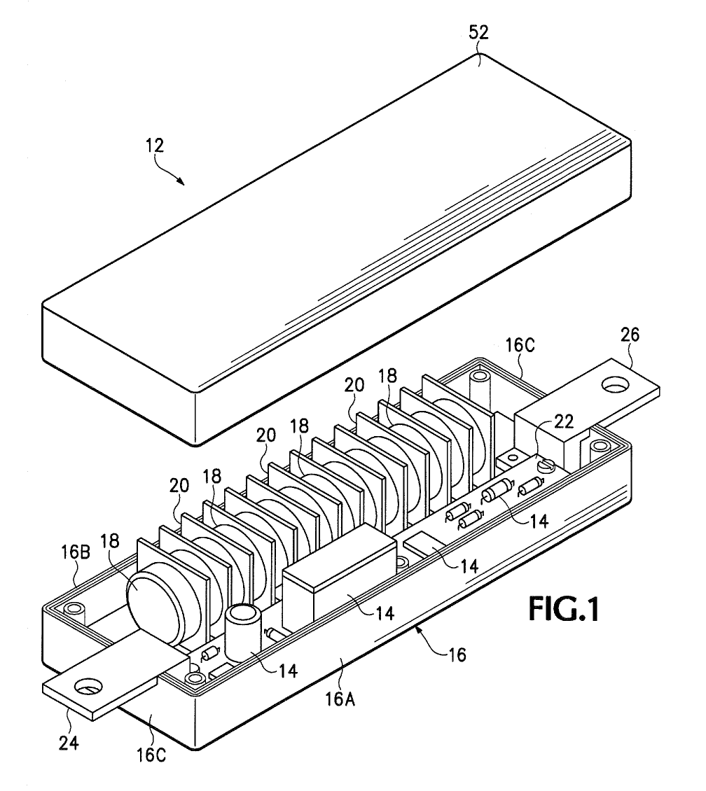

FIG. 1 shows a surge suppression unit 12 that includes multiple Metal Oxide Varistors (MOVs) 18 connected to a printed circuit board 22. Other electrical circuitry and components 14 are also connected to the circuit board 22. A power line or neutral line (not shown) is connected to a first terminal 24 and a ground line or neutral line (not shown) is connected to a second terminal 26. The circuit board 22, varistors 18 and other electrical components 14 are all contained within an enclosure 16. The enclosure 16 includes front and back walls 16A and 16B, respectively, and side walls 16C. A top cover 52 attaches over walls 16A-16C.

The MOVs (varistors) 18 provide a high resistance path between the line connected to terminal 24 and the line connected to terminal 26. For instance, when a power surge occurs on a power line connected to terminal 24, one or more of the varistors 18 start conducting, redirecting the power surge away from electrical equipment (not shown) connected to the power line and either to a neutral line or ground line connected to terminal 26.

As also mentioned above, the power surge while being redirected to terminal 26 can cause the varistors 18 to heat up enough to start burning or blow up. The power surge can also create arcing between the conducting varistor 18 and other varistors 18 or create arcing between the conducting varistor 18 and the other electrical components 14 on circuit board 22. These fires, explosions, and arcing can damage the other varistors 18 and other electrical components 14, possibly to the extent of rendering the entire surge suppression unit 12 inoperable.

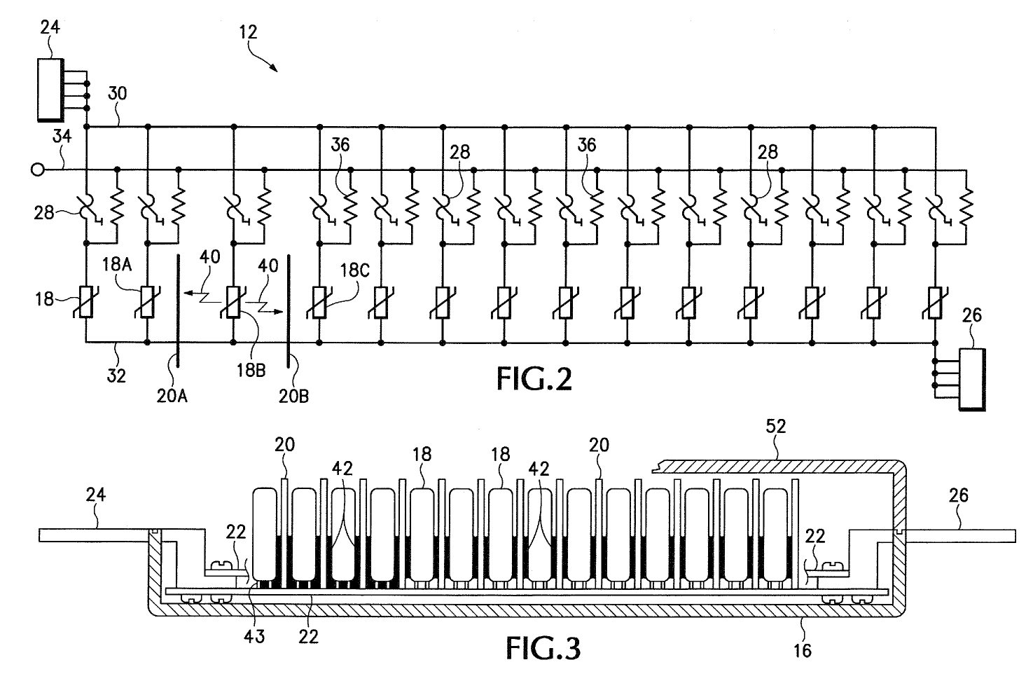

FIG. 2 shows one example of a circuit diagram for the surge suppression unit 12 shown in FIG. 1. The terminal 24 is connected through conductor 30 to each of the varistors 18 via associated fuses 28. The opposite end of each varistor 18 is connected through conductor 32 to the terminal 26. A power sensing line 34 is connected to each varistor 18 through resistors 36. FIG. 3 shows a side sectional view of the surge suppression unit 12 shown in FIG. 1.

Referring to FIGS. 1-3, to reduce the effects of fires, explosions and arcing, separator or spacer walls 20 extend vertically up between the adjacent varistors 18. The separator walls 20 impede arcing paths between the conducting varistor 18 and other varistors 18, and also impede any arcing paths between the conducting varistor 18 and the other electrical components 14.

In one embodiment, the anti-arcing separator walls 20 are made of a fire resistant fiber, plastic, ceramic or fiberglass insulating material, such as fiberglass based GP03. In another embodiment, the separator walls 20 may be made from a honeycombed plastic or fiberglass material. However, any material that has a high insulating factor can be used. The separator walls 20 in this embodiment have a height that extends over the top of each adjacent varistor and a width that extends along the entire width of each adjacent varistor 18 from a front end to a back end. In this embodiment, each separator 20 is approximately two inches tall, two inches wide and approximately ⅙^{th} inch thick. Of course, the dimensions of the separators 20 can vary depending on the size of the adjacent varistors 18 and the amount of desired arc retardation.

FIG. 2 shows a separator wall 20A located between varistors 18A and 18B and separator wall 20B located between varistors 18B and 18C. The separators 20A and 20B prevent an electrical power surge that is conducted through one of the varistors 18B, for example, from arcing 40 to varistor 18A or varistor 18C. This allows the surge suppression unit 12 to withstand multiple power surges while still providing suppression for subsequent power surges. The fuses 28 disconnect the power surge when the varistors 18 get too hot. Because, the varistors 18 are less likely to arc, the fuses 28 can, but are not required to, have higher current ratings. Thus, the surge suppression unit 12 may maintain a higher power surge rating while at the same time having increased resilience to power surges.

The separator walls 20 allow a substantially open area around each one of the varistors 18 while at the same time isolating each varistor 18 from adjacent varistors and other electrical components 14. In one embodiment, this is preferred over other alternative anti-arcing arrangements and materials that might be tightly compacted or encased around each varistor 18. Tightly compacting materials around the varistors 18 could actually increase the negative effects from an explosion. For example, a material tightly encased around a varistor 18 may create more pressure around the varistor 189 during a power surge resulting in a larger explosion and the projection of additional shrapnel from encasing material. The separator walls 20 allow air to freely circulate around the varistors 18 thus mitigating pressure buildup and the resulting explosion.

In another embodiment, the separator walls 20 may also be located in front and behind each varistor 18. In this embodiment, each varistor 18 might be completely surrounded and contained by separator walls 20. This may include a first unitary piece of separator wall material that extends in front of all of the varistors 18 and a second unitary piece of separator wall material that extends behind all of the varistors 18. The separator walls 18 would still be located between the varistors 18 with the front ends abutting against the front separator and the back ends abutting against the back separator. Alternatively, there may be individual front and back separator walls for each varistor 18.

In one embodiment, an epoxy or fiberglass material 42 may be laid down in between the varistors 18. The separator walls 20 are then inserted into the wet epoxy to anchor the separators to the printed circuit board or against the sides of the varistors 18. The epoxy 42 may extend underneath all of the varistors 18 in between and around the wires 43 that extend from the bottom of the varistors 18 and connect the varistors 18 to the printed circuit board 22. Alternatively, the epoxy may be applied to the sides and in between the varistors 18. The epoxy 42 can be an electronic module potting epoxy with flame retardant. The epoxy 42 further retards arcing that may occur between the varistors 18 and the conductors 43 that connect the varistors 18 to the printed circuit board 22 while the separator walls 20 retard the arching between adjacent varistors 18.

In an alternative embodiment, separator walls 20 are compressively held in place by the adjacent varistors 18. The varistors 18 are spaced close enough together so that the separators 20 can be slid in between the varistors 18 and then held vertically upright on opposite sides by the adjacent varistors 18. Clips or slots in the printed circuit board 22 can also be used to hold the separators 20 upright.

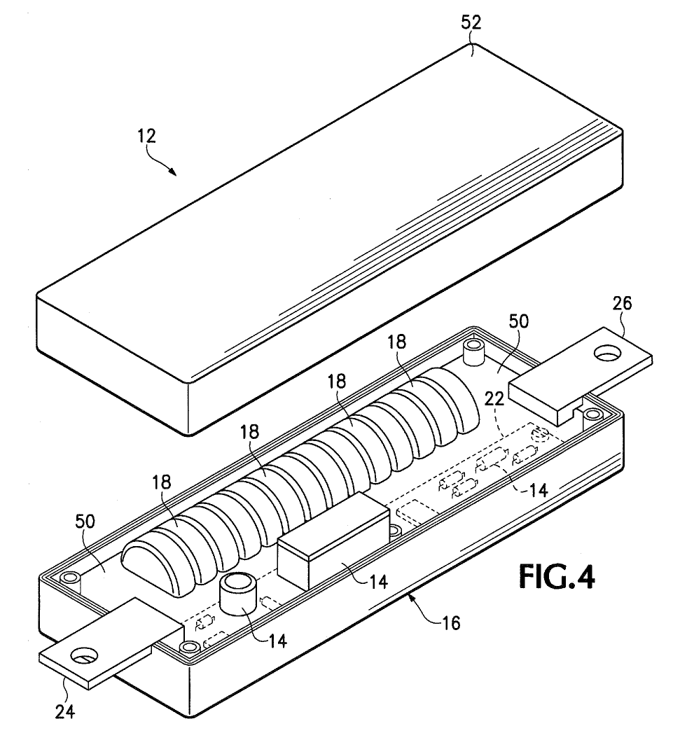

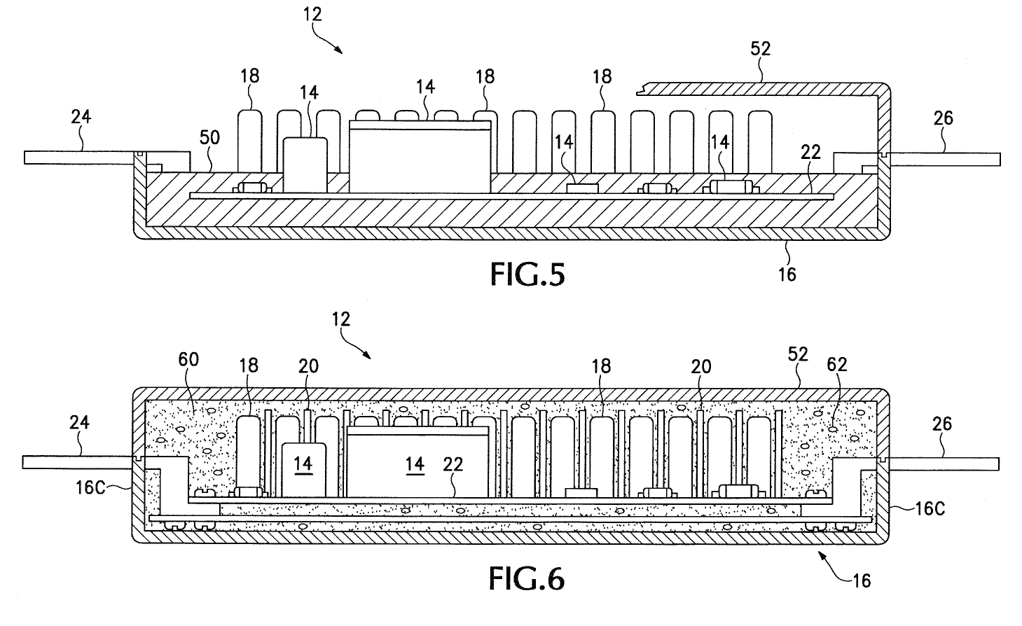

FIG. 4 shows a top view of an alternative embodiment of the surge suppression unit 12. FIG. 5 shows a side sectional view of the surge suppression unit 12 shown in FIG. 4. In this embodiment, the epoxy 50 covers the entire top surface of the circuit board 22. The epoxy 50 covers substantially all of the electrical components 14, other than the varistors 18, that are located on the top of the circuit board 22. Some of the other larger profile electrical components 14 and 18 may only be partially covered with the epoxy 50. The epoxy 50 may be made of a non-conductive resin, plastic, or fiberglass material that impedes arcing between the varistors 18 and the other electrical components 14 and conductors on printed circuit board 22. The varistors 18 are not completely covered in epoxy 50, to avoid possibly increasing the explosive effects that may result by completely encasing each varistor 18.

FIG. 6 shows yet another embodiment of the surge suppression unit 12 that contains sand 60 for retarding arcing and reducing the effects of explosions and fires. The porous sand and air existing between the sand granules prevent the same shrapnel effects that may result from encasing the varistors in denser insulating materials. A fire retardant material 62 may be combined with the sand 60 to further retard arcing and the effects of fires or explosions within the enclosure 16. A similar material used in fire extinguishers, such as monoammonium phosphate may be used for fire retardant 62. In one embodiment, a 50/50 mixture of sand 60 and fire retardant material 62 is used. Of course, other types of fire retardants 62 and fire retardant/sand ratios might also be used. Epoxy can also be spread over the sand 60 to keep it retained within enclosure 16.

Any combination of the separator walls 20 and epoxy 50 may also be used along with the sand 60. The sand 60 is simply poured into the opening formed by enclosure 16. The top cover 52 is then attached over the top of enclosure 16 to hold in the sand 60.

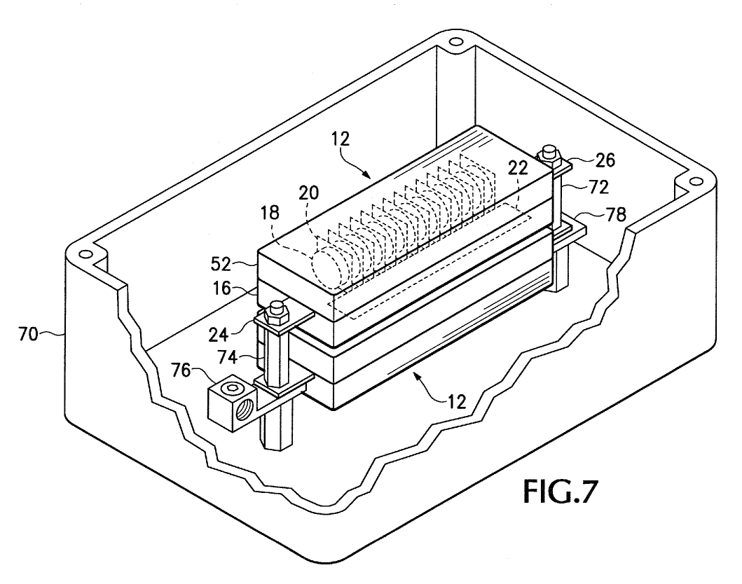

FIG. 7 shows two of the surge suppression units 12 stacked vertically on top of each other inside of an enclosure 70. The two suppression units 12 are coupled together at a first end by a connector post 72 and at a second end by a connector post 74. The connector post 72 electrically couples terminal 26 to a bus bar 78 that is coupled to neutral or ground. The post 74 electrically couples terminal 24 to a power line connector 76. The MOVs 18 extend along substantially the entire length of the circuit board 22 and each is separated by one of the anti-arcing separator or divider walls 20.

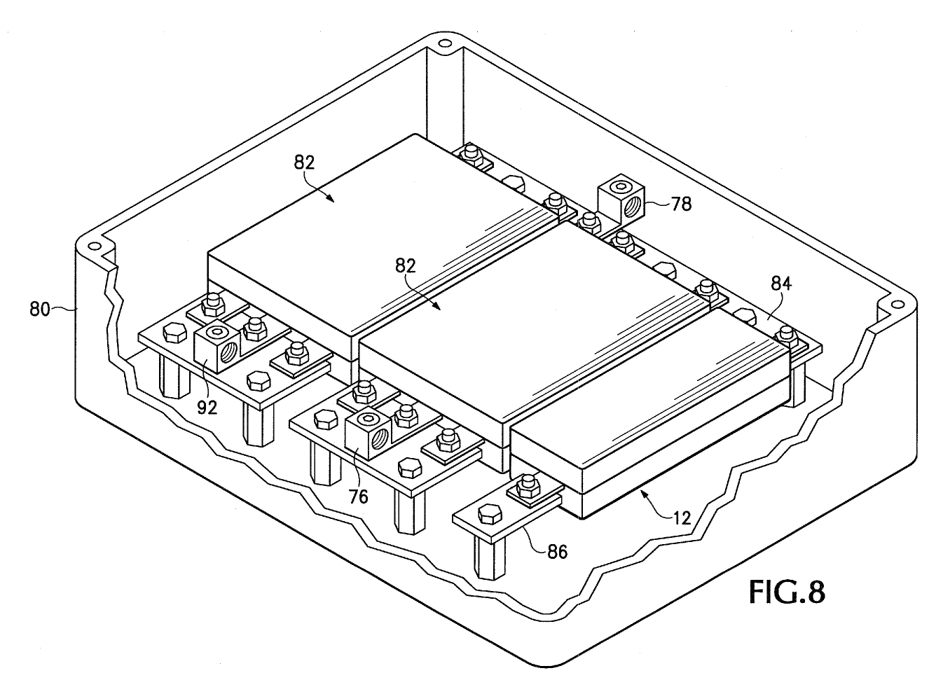

This is just one example of how the surge suppression units 12 can be arranged. In other embodiments, the enclosure 70 may only contain one surge suppression unit 12 or alternatively may contain multiple different sized suppression units. For example, FIG. 8 shows a power surge protection assembly 80 that includes both larger sized suppression units 82 and smaller sized suppression units 12 connected side-by-side. The surge suppression units 82 may include similar power surge protection components at surge suppression units 12 previously described above in FIGS. 1-7. However, the larger sized surge suppression units 82 may include more surge suppression components, such as more MOVs 18.

In this example, the smaller surge suppression unit 12 is coupled between a neutral terminal 78 via bus bar 84 and ground via bus bar 86. The larger suppression units 82 provide additional surge suppression protection between power line terminals 92 and 76 and neutral line terminal 78. Any one, or all, of the surge suppression units 82 and/or 12 can include any combination of the anti-arc separator walls 20, epoxy 50, and/or sand 60 described above. Thus, each of the surge suppression units is more resilient to arcing, fires, explosions, and general destruction during a power surge.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A surge suppression unit, comprising:
a circuit board containing a plurality of electrical surge suppression components configured in parallel, side-by-side relationship perpendicularly to the circuit board to redirect power surges; and
anti-arcing separator walls located vertically in between each of the electrical surge suppression components that reduce or prevent electrical arcing between adjacent electrical surge suppression components;
wherein the anti-arcing separator walls are configured to extend vertically from the circuit board up to at least a top end of each adjacent electrical surge suppression component and extend from a front end to a back end of each adjacent electrical surge suppression component.

2. (canceled)

3. The surge suppression unit according to claim 1 wherein the anti-arcing separator walls are each made from a fire retardant material and aligned vertically upright and in parallel between adjacent MOVs or SADs.

4. The surge suppression unit according to claim 1 including a layer of epoxy spread in between the electrical surge suppression components to hold the anti-arcing separator walls upright between the adjacent electrical surge suppression components while at the same time retarding arcing between the electrical surge suppression components and the circuit board.

5. A surge suppression unit, comprising:
a circuit board containing a plurality of electrical surge suppression components configured in parallel, side-by-side relationship perpendicularly to the circuit board to redirect power surges; and
anti-arcing separator walls located vertically in between each of the electrical surge suppression components that reduce or prevent electrical arcing between adjacent electrical surge suppression components; and
epoxy spread over substantially an entire top surface of the printed circuit board covering a lower portion of the electrical surge suppression components; an upper portion of the electrical surge suppression components remaining uncovered by the epoxy.

6. (canceled)

7. (canceled)

8. A method, comprising:
spacing side by side a plurality of parallel electrical surge suppression components vertically on a top surface of a circuit board within an enclosure that is configured to activate during a power surge and then during activation to redirect the power surge away from electrical equipment; and
locating a plurality of vertically-extending anti-arcing walls interleaved between each of the electrical surge suppression components to retard arcing while the electrical surge suppression components are activated and redirecting the power surge; and
spreading a layer of epoxy on the top surface of the circuit board between each of the adjacent electrical surge suppression components and then attaching the anti-arcing walls to the epoxy.

9. (canceled)

10. (canceled)

11. The method according to claim 8 including spreading an the epoxy material over substantially an entire the top surface of a printed circuit board that contains the electrical surge suppression components to a depth that completely covers a lower portion of the electrical surge suppression components while leaving most of the electrical surge suppression components uncovered by the epoxy.

12. (canceled)

13. (canceled)

14. An apparatus for retarding arcing in a surge suppression unit, comprising:
a circuit board;
a plurality of Metal Oxide Varistors (MOVs) or Silicon Avalanche Diodes (SAD) mounted in parallel side-by-side relationship perpendicular on the circuit board for suppressing electrical power surges; and
a plurality of arc retardant walls extending perpendicularly to the circuit board interleaved between the MOVs or SADs that retard arcing between adjacent MOVs or SADs when the MOVs or SADs are conducting and directing the power surge from a first terminal to a second terminal.

15. (canceled)

16. The apparatus according to claim 14 including a layer of epoxy located on the circuit board covering only a lower portion of the MOVs or SADs and the arc retardant walls.

17. The apparatus according to claim 16 wherein the layer of epoxy covers substantially an entire top surface of the circuit board that contains the MOVs or SADs.

18. The apparatus according to claim 14 including sand substantially filling up an enclosure containing the MOVs or SADs.

19. The apparatus according to claim 18 including fire retardant granules intermixed with the sand inside the enclosure.
